(19) United States
(12) Patent Application Publication
(10) Pub. No.: US 2024/0301989 A1
(43) Pub. Date: Sep. 12, 2024

(54) DISPLAY STAND DEVICE

(71) Applicant: BENQ CORPORATION, Taipei City (TW)

(72) Inventor: Shih-Ho Chen, Taipei City (TW)

(73) Assignee: BENQ CORPORATION, Taipei City (TW)

(21) Appl. No.: 18/337,402

(22) Filed: Jun. 19, 2023

(30) Foreign Application Priority Data
Mar. 6, 2023 (TW) 112107967

(51) Int. Cl. F16M 11/04; F16M 11/10; F16M 11/20; F16M 11/28

(52) U.S. Cl. CPC F16M 11/046; F16M 11/045; F16M 11/105; F16M 11/2014; F16M 11/2092; F16M 11/28

(57) ABSTRACT

A display stand device is adapted for a display and includes a base, a first rotation member, a telescopic assembly, a track, and a motion assembly. The first rotation member is rotatably disposed on the base along a first axial direction. The telescopic assembly is telescopically disposed on the first rotation member along a second axial direction. The second axial direction is perpendicular to the first axial direction. The track is fixably disposed on the telescopic assembly along the first axial direction. The motion assembly is movably disposed on the track along the first axial direction and is adapted to be attached to the back of the display, so that the display linearly moves and rotates along the first axial direction relative to the base and rotates along a third axial direction. The third axial direction is perpendicular to the first axial direction and the second axial direction.

### CROSS-REFERENCE TO RELATED APPLICATION

This application claims the priority benefit of Taiwan application serial no. 112107967, filed on Mar. 6, 2023. The entirety of the above-mentioned patent application is hereby incorporated by reference herein and made a part of this specification.

### BACKGROUND

### Technical Field

The disclosure relates to a stand device, and in particular, to a display stand device.

### Description of Related Art

The stand of the existing display is mainly composed of multiple rods pivotally connected to each other, and cannot simply move linearly. Therefore, when the display is fixed on such a stand, it is difficult for the user to smoothly and linearly move the display forward or backward to adjust the distance of the display.

### SUMMARY

The disclosure provides a display stand device, which may provide a linear movement and a rotation, so as to better adjust a position and an angle of the display.

A display stand device of the disclosure is adapted for a display and includes a base, a first rotation member, a telescopic assembly, a track, and a motion assembly. The first rotation member is rotatably disposed on the base along a first axial direction. The telescopic assembly is telescopically disposed on the first rotation member along a second axial direction. The second axial direction is perpendicular to the first axial direction. The track is fixably disposed on the telescopic assembly along the first axial direction. The motion assembly is movably disposed on the track along the first axial direction and is adapted to be attached to the back of the display, so that the display linearly moves and rotates along the first axial direction relative to the base and rotates along a third axial direction. The third axial direction is perpendicular to the first axial direction and the second axial direction.

Based on the above, the first rotation member of the display stand device of the disclosure is rotatably disposed on the base along the first axial direction, the telescopic assembly is telescopically disposed on the first rotation member along the second axial direction, and the track is fixably disposed on the telescopic assembly along the first axial direction. The motion assembly is movably disposed on the track along the first axial direction and is adapted to be attached to the back of the display. Therefore, the display may linearly move and rotate along the first axial direction relative to the base and rotate along a third axial direction. The display stand device of the disclosure may better adjust the position and the angle of the display due to being capable of providing the linear movement and the multi-axis rotation.

### BRIEF DESCRIPTION OF THE DRAWINGS

FIG. 1 is a schematic perspective view of a display stand device according to an embodiment of the disclosure.

FIG. 2 is a schematic side view of the display stand device of FIG. 1.

FIG. 3 is a schematic partial perspective view of the telescopic assembly of the display stand device of FIG. 1.

FIG. 4A and FIG. 4B are schematic views of an appearance of the fastening member of the display stand device of FIG. 1 before and after fastening.

FIG. 4C is a schematic partial cross-sectional view in the state of FIG. 4B.

FIG. 5A and FIG. 5B are schematic views of an appearance of a fastening member of a display stand device before and after fastening according to another embodiment of the disclosure.

FIG. 5C is a schematic partial cross-sectional view in the state of FIG. 5B.

FIG. 6A to FIG. 6C are schematic views of a folding process of the display stand device of FIG. 1.

### DESCRIPTION OF THE EMBODIMENTS

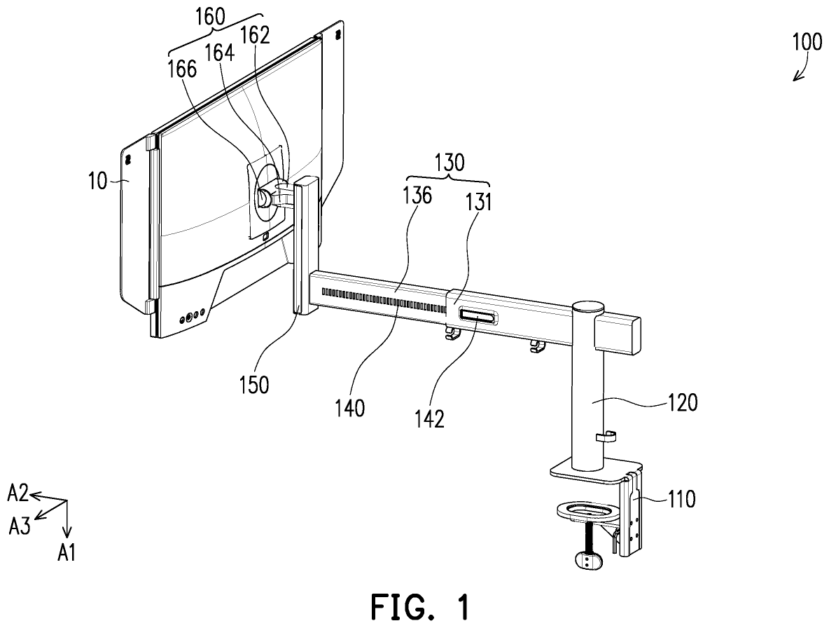

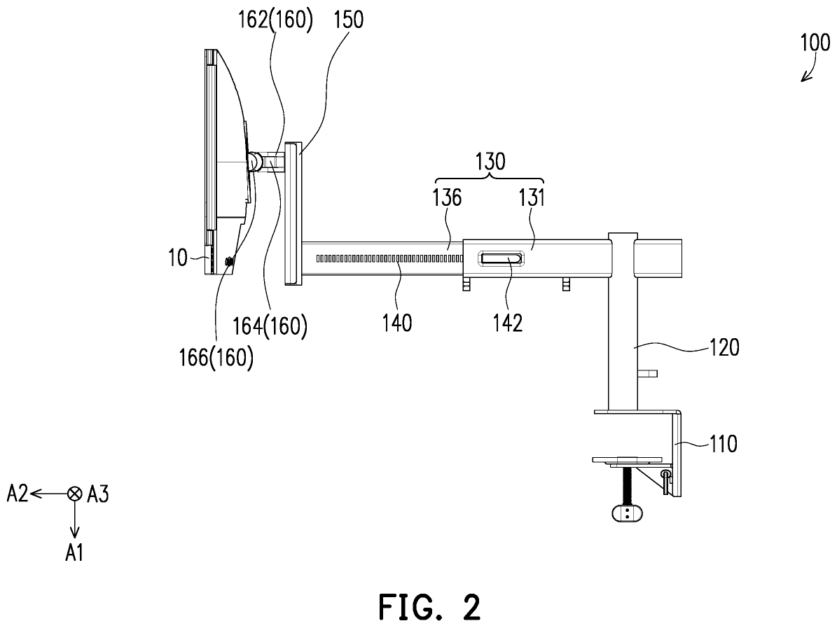

FIG. 1 is a schematic perspective view of a display stand device according to an embodiment of the disclosure. FIG. 2 is a schematic side view of the display stand device of FIG. 1. Referring to FIG. 1 and FIG. 2, a display stand device 100 of the embodiment is adapted for a display 10, such as a computer screen. Alternatively, the display 10 may also be a television, and the type of the display 10 is not limited thereto.

The display stand device 100 includes a base 110, a first rotation member 120, a telescopic assembly 130, a track 150, and a motion assembly 160. In the embodiment, the base 110 is a clamp, which may be clamped on the edge of the table to allow space on the table for placing other objects. In other embodiments, the base 110 may also be a structure placed directly on the desktop, and the type of the base 110 is not limited thereto.

The first rotation member 120 is rotatably disposed on the base 110 along a first axial direction A1 and may rotate relative to the base 110 along the first axial direction A1.

The telescopic assembly 130 is telescopically disposed on the first rotation member 120 along a second axial direction A2. The second axial direction A2 is perpendicular to the first axial direction A1. In the embodiment, the telescopic assembly 130 includes a fixed sleeve 131 and a sliding member 136. The fixed sleeve 131 is fixed on the first rotation member 120. The sliding member 136 is slidably disposed on the fixed sleeve 131 along the second axial direction A2 so as to retract into or protrude from the fixed sleeve 131.

Therefore, the sliding member 136 may move in a direction away from the first rotation member 120 to extend the telescopic assembly 130 and enable the display 10 to be closer to the user. The sliding member 136 may also move towards the direction of the first rotation member 120 to shorten the telescopic assembly 130 and enable the display 10 to be farther away from the user.

In the embodiment, the telescopic assembly 130 passes through the first rotation member 120 and is located on two opposite sides of the first rotation member 120. Specifically, a part of the fixed sleeve 131 is located on the right side of the first rotation member 120 in FIG. 1 and above the base 110. Such a design may increase the length of the fixed sleeve 131, thereby increasing the retractable path of the sliding member 136, so that the length of the sliding member 136 may be increased and a larger linear movement range may be provided.

In other embodiments, even if the part of the fixed sleeve 131 located on the right side of the first rotation member 120 in FIG is not used as a retractable space for the sliding member 136, a counterweight (not shown) can also be placed in the part to increase the clockwise moment on the right side of the first rotation member 120 for improving the balance. Therefore, even if the telescopic assembly 130 is elongated and has a large moment arm relative to the first rotation member 120, and the display 10 has a large counterclockwise moment relative to the first rotation member 120 due to the display 10 being installed on the display stand device 100, the telescopic assembly 130 does not sag due to the large counterclockwise moment of the display 10.

Of course, in other embodiments, the part of the fixed sleeve 131 located on the right side of the first rotation member 120 in FIG. 1 may be used as a retractable space for the sliding member 136 and a space for placing the counterweight at the same time.

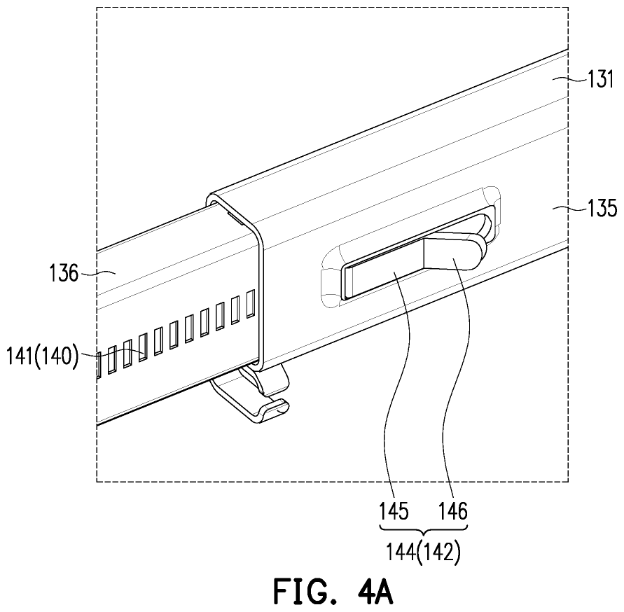

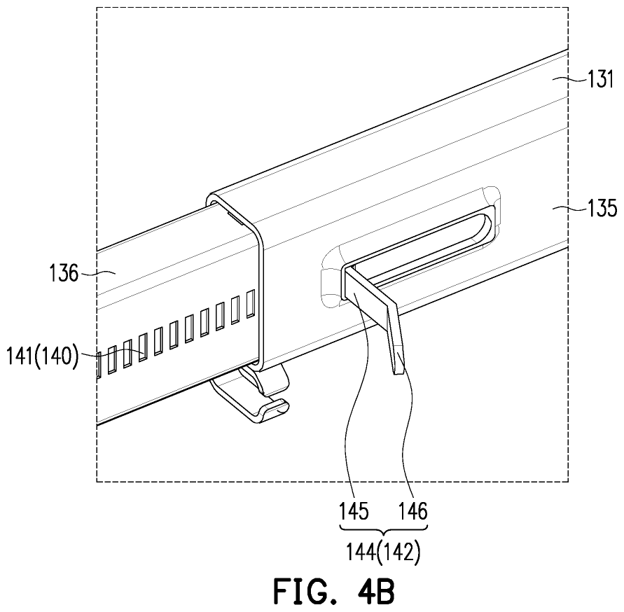

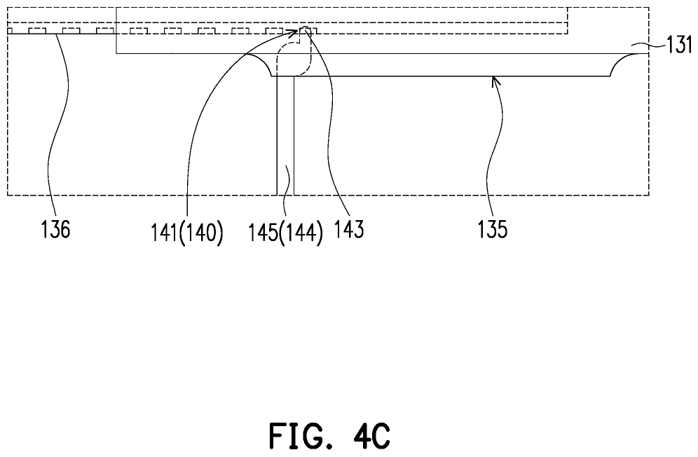

In addition, in the embodiment, a ruler 140 is disposed on the outer surface of the sliding member 136, and the ruler 140 is exposed when the sliding member 136 protrudes from the fixed sleeve 131 so as to display the protrusion size of the sliding member 136, which is convenient for the user to operate. Specifically, the ruler 140 includes multiple grooves 141 (FIG. 4A) arranged along the second axial direction A2, but the type of the ruler 140 is not limited thereto. In other embodiments, the ruler 140 may also be a row of protrusions or a mark printed on the outer surface of the sliding member 136.

In addition, the track 150 is fixably disposed on the sliding member 136 of the telescopic assembly 130 along the first axial direction A1. The motion assembly 160 is movably disposed on the track 150 along the first axial direction A1 and is adapted to be attached to the back of the display 10.

Specifically, in the embodiment, the motion assembly 160 includes a slider 162, a second rotation member 164, and an inclination adjustment member 166. The slider 162 is disposed on the track 150, the second rotation member 164 is disposed on the slider 162, the inclination adjustment member 166 is disposed on the second rotation member 164, and the display 10 is disposed on the inclination adjustment member 166.

In detail, in the embodiment, the slider 162 is movably disposed on the track 150 along the first axial direction A1, so that the display 10 may linearly move relative to the base 110 along the first axial direction A1. Therefore, the user may drive the slider 162 by moving the display 10 so that the display 10 may move upward or downward.

The second rotation member 164 is rotatably disposed on the slider 162 along the first axial direction A1, so that the display 10 may rotate relative to the base 110 along the first axial direction A1. Therefore, the user may drive the second rotation member 164 by pulling the display 10, so that the display 10 may be rotated leftward or rightward.

The inclination adjustment member 166 is rotatably disposed on the second rotation member 164 along a third axial direction, so that the display 10 may rotate along a third axial direction A3. The third axial direction is perpendicular to the first axial direction and the second axial direction. Therefore, the user may drive the inclination adjustment member 166 by pulling the display 10, so that the display 10 may be rotated upward or downward.

Therefore, the display stand device 100 of the embodiment may better adjust the position and the angle of the display 10 due to being capable of providing the linear movement and the multi-axis rotation.

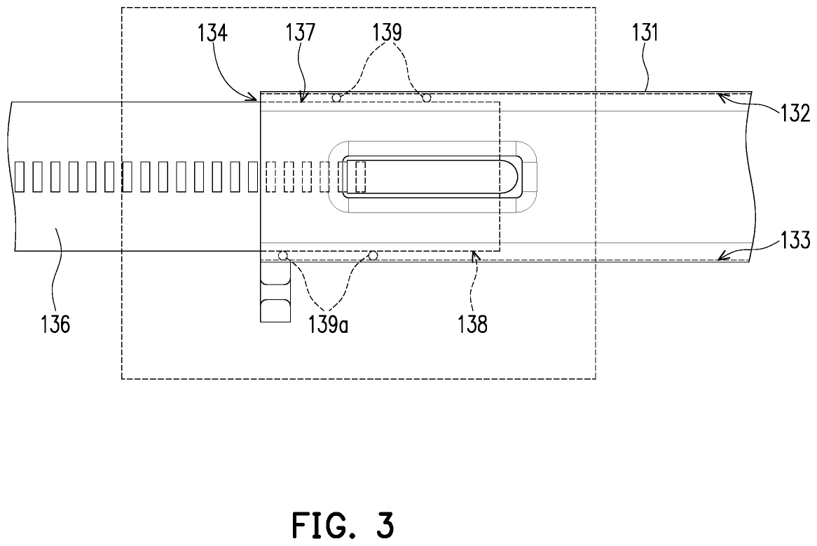

FIG. 3 is a schematic partial perspective view of the telescopic assembly of the display stand device of FIG. 1. Referring to FIG. 3, in the embodiment, a first top wall 132 of the fixed sleeve 131 faces a second top wall 137 of the sliding member 136, and a first bottom wall 133 of the fixed sleeve 131 faces a second bottom wall 138 of the sliding member 136. The telescopic assembly 130 also includes multiple bearings 139 and 139a. The bearings 139 are close to an opening 134 of the fixed sleeve 131 and are located between the first top wall 132 and the second top wall 137. The bearings 139a are close to the opening 134 and are located between the first bottom wall 133 and the second bottom wall 138.

In addition, as may be seen from FIG. 3, in the embodiment, the projections of the bearings 139 located between the first top wall 132 and the second top wall 137 on the first bottom wall 133 are staggered from the projections of the bearings 139a located between the first bottom wall 133 and the second bottom wall 138 on the first bottom wall 133. More specifically, the projections of the bearings 139 located between the first top wall 132 and the second top wall 137 on the first bottom wall 133 and the projections of the bearings 139a located between the first bottom wall 133 and the second bottom wall 138 on the first bottom wall 133 are disposed in a staggered manner.

In the embodiment, the sliding member 136 may slide on the fixed sleeve 131 stably and smoothly through the above configuration.

FIG. 4A and FIG. 4B are schematic views of an appearance of the fastening member of the display stand device of FIG. 1 before and after fastening. FIG. 4C is a schematic partial cross-sectional view in the state of FIG. 4B. Referring to FIG. 4A to FIG. 4C, in the embodiment, a fastening member 142 is rotatably disposed on the fixed sleeve 131. Specifically, the fastening member 142 may be rotatably disposed on the fixed sleeve 131 along the vertical direction (that is, the first axial direction A1 of FIG. 1) and abut against the fixed sleeve 131 or stand upright relative to the fixed sleeve 131.

In the embodiment, the ruler 140 on the fixed sleeve 131 is in the form of a groove 141. The fastening member 142 has a handle 144 and a block 143 (FIG. 4C). The fastening member 142 may be in an unlocked position as shown in FIG. 4A. At this time, the handle 144 is close to an outer side wall 135 of the fixed sleeve 131, and the block 143 (FIG. 4C) has not yet extended into the groove 141. Therefore, the sliding member 136 may slide relative to the fixed sleeve 131.

As shown in FIG. 4A, the handle 144 includes a first section 145 and a second section 146 bently connected to the first section 145. When the fastening member 142 is in the unlocked position (FIG. 4A), the first section 145 is attached to the outer side wall 135, and the second section 146 is upturned from the outer side wall 135. Therefore, the user may easily pull the second section 146 of the handle 144 to rotate the fastening member 142 along the first axial direction A1.

When the user turns the handle 144 so that the handle 144 may stand upright on the outer side wall 135 of the fixed sleeve 131 and the fastening member 142 may be in a fixed position as shown in FIG. 4B and FIG. 4C, the block 143 is embedded in one of the grooves 141 to fix the relative position between the sliding member 136 and the fixed sleeve 131. Certainly, the form and the operation mode of the fastening member 142 are not limited thereto.

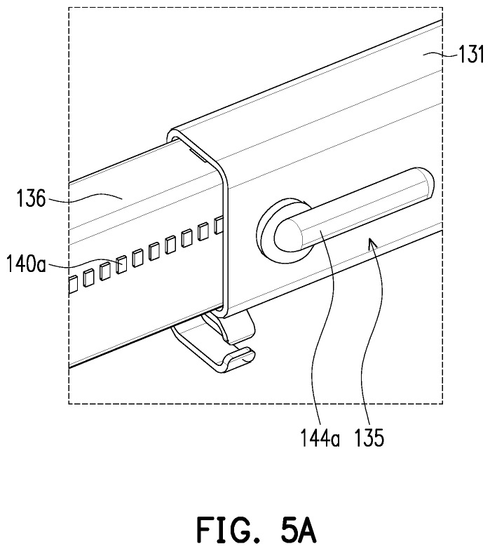

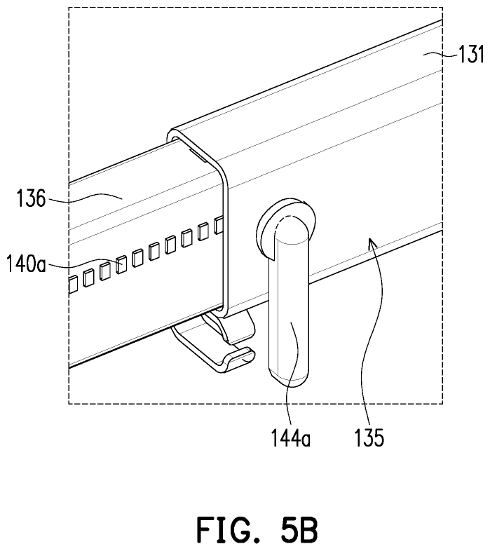

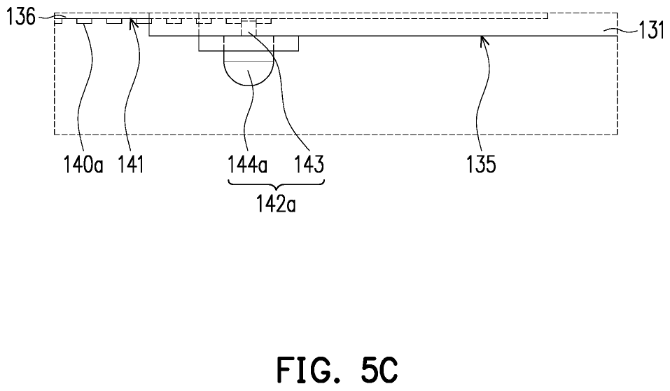

FIG. 5A and FIG. 5B are schematic views of an appearance of a fastening member of a display stand device before and after fastening according to another embodiment of the disclosure.

FIG. 5C is a schematic partial cross-sectional view in the state of FIG. 5B. Referring to FIG. 5A to FIG. 5C, in the embodiment, a fastening member 142a is rotatably disposed on the fixed sleeve 131 along the normal direction of the outer side wall 135 (that is, the third axial direction A3 of FIG. 1). A handle 144a of the fastening member 142a rotates along the outer side wall 135 of the fixed sleeve 131 between the fixed position of the fastening member 142a (as in FIG. 5A, where the handle 144a is horizontal) and the unlocked position of the fastening member 142a (as in FIG. 5B, where the handle 144a is vertical).

In the embodiment, a ruler 140a on the fixed sleeve 131 is in the form of a protrusion. As shown in FIG. 5C, when the fastening member 142a is at a fixed position, the block 143 of the fastening member 142a extends into the gap between two adjacent protrusions to fix the relative position between the sliding member 136 and the fixed sleeve 131.

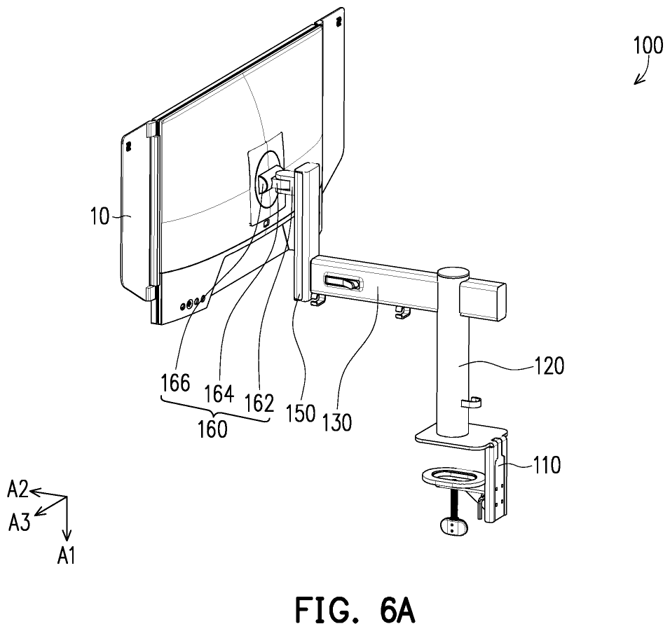

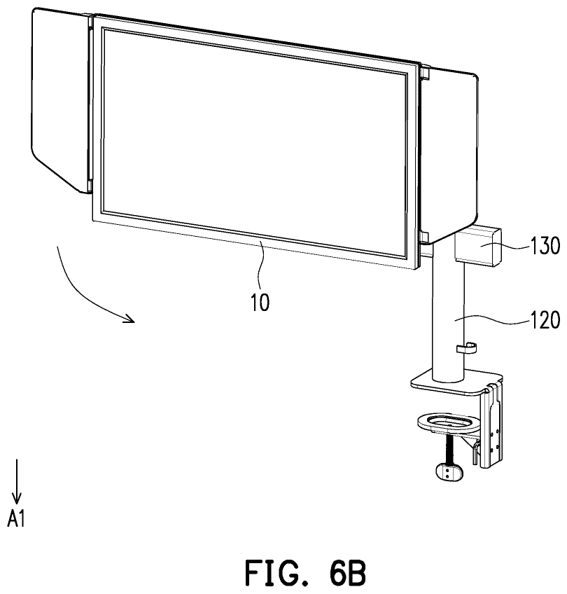

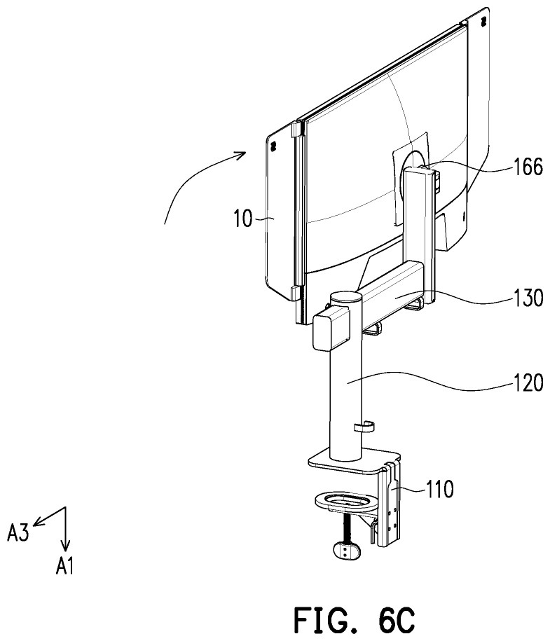

FIG. 6A to FIG. 6C are schematic views of a folding process of the display stand device of FIG. 1. Referring to FIG. 6A first, when the display stand device 100 is to be stored together with the display 10 in the storage position (FIG. 6C) to reduce the space occupied on the desktop, the display 10 may be moved to the stand along the second axial direction A2 first, so that the telescopic assembly 130 is shortened to the shortest. That is, the sliding member 136 of FIG. 1 is fully extended into the fixed sleeve 131.

Next, referring to FIG. 6B, since the second rotation member 164 may rotate along the first axial direction A1 relative to the slider 162, the display 10 and the inclination adjustment member 166 are rotated along the first axial direction A1 with the second rotation member 164 as the rotation axis, so that the display 10 is leaned against the telescopic assembly 130 and is parallel to the telescopic assembly 130.

Further, referring to FIG. 6C, since the first rotation member 120 may rotate along the first axial direction A1 relative to the base 110, the display 10 may be rotated along the first axial direction A1 with the first rotation member 120 as the rotation axis, so that the display 10 and the telescopic assembly 130 are rotated to a position parallel to the third axial direction A3 and located above the base 110. Therefore, the display stand device 100 together with the display 10 may largely free up the space on the desktop, so that other operations may be performed on the desktop.

To sum up, the first rotation member of the display stand device of the disclosure is rotatably disposed on the base along the first axial direction, the telescopic assembly is telescopically disposed on the first rotation member along the second axial direction, and the track is fixably disposed on the telescopic assembly along the first axial direction. The motion assembly is movably disposed on the track along the first axial direction and is adapted to be attached to the back of the display. Therefore, the display may linearly move and rotate along the first axial direction relative to the base and rotate along the third axial direction. The display stand device of the disclosure may better adjust the position and the angle of the display due to being capable of providing the linear movement and the multi-axis rotation.

What is claimed is:

1. A display stand device, adapted for a display, comprising:
a base;
a first rotation member, rotatably disposed on the base along a first axial direction;
a telescopic assembly, telescopically disposed on the first rotation member along a second axial direction, wherein the second axial direction is perpendicular to the first axial direction;
a track, fixably disposed on the telescopic assembly along the first axial direction; and
a motion assembly, movably disposed on the track along the first axial direction, and adapted to be attached to the back of the display, so that the display linearly moves and rotates relative to the base along the first axial direction and rotates along a third axial direction, wherein the third axial direction is perpendicular to the first axial direction and the second axial direction.

2. The display stand device according to claim 1, wherein the telescopic assembly comprises a fixed sleeve and a sliding member, the fixed sleeve is fixed on the first rotation member, the sliding member is slidably disposed on the fixed sleeve along the second axial direction so as to retract or protrude from the fixed sleeve, and the track is fixably disposed on the sliding member.

3. The display stand device according to claim 2, wherein the telescopic assembly further comprises a plurality of bearings, a first top wall of the fixed sleeve faces a second top wall of the sliding member, a first bottom wall of the fixed sleeve faces a second bottom wall of the sliding member, and a part of the bearings is close to an opening of the fixed sleeve and is located between the first top wall and the second top wall.

4. The display stand device according to claim 3, wherein an another part of the bearings is close to the opening and is located between the first bottom wall and the second bottom wall.

5. The display stand device according to claim 4, wherein projections of the part of the bearings located between the first top wall and the second top wall on the first bottom wall are staggered from projections of the another part of the bearings located between the first bottom wall and the second bottom wall on the first bottom wall.

6. The display stand device according to claim 4, wherein projections of the part of the bearings located between the first top wall and the second top wall on the first bottom wall and projections of the another part of the bearings located between the first bottom wall and the second bottom wall on the first bottom wall are disposed in a staggered manner.

7. The display stand device according to claim 2, wherein an outer surface of the sliding member is disposed with a ruler, and the ruler is exposed when the sliding member protrudes from the fixed sleeve so as to display a protrusion size of the sliding member.

8. The display stand device according to claim 7, wherein the ruler comprises a plurality of grooves arranged along the second axial direction.

9. The display stand device according to claim 8, wherein a fastening member is rotatably disposed on the fixed sleeve, the fastening member has a block, and the block is embedded in one of the grooves to fix the relative position between the sliding member and the fixed sleeve when the fastening member is in a fixed position.

10. The display stand device according to claim 9, wherein the block exits the groove when the fastening member is in an unlocked position.

11. The display stand device according to claim 9, wherein the fastening member is rotatably disposed on the fixed sleeve along the first axial direction.

12. The display stand device according to claim 11, wherein the fastening member has a handle, the handle stands upright on an outer side wall of the fixed sleeve when the fastening member is in the fixed position, and the handle is attached to the outer side wall of the fixed sleeve when the fastening member is in an unlocked position.

13. The display stand device according to claim 12, wherein the handle comprises a first section and a second section bently connected to the first section, and the first section is attached to the outer side wall and the second section is upturned from the outer side wall when the fastening member is in the unlocked position.

14. The display stand device according to claim 9, wherein the fastening member is rotatably disposed on the fixed sleeve along the third axial direction.

15. The display stand device according to claim 14, wherein the fastening member has a handle, and the handle rotates along an outer side wall of the fixed sleeve between the fixed position and an unlocked position of the fastening member.

16. The display stand device according to claim 1, wherein the motion assembly comprises a slider and a second rotation member, the slider is movably disposed on the track along the first axial direction, and the second rotation member is rotatably disposed on the slider along the first axial direction.

17. The display stand device according to claim 16, wherein the motion assembly comprises an inclination adjustment member, and the inclination adjustment member is rotatably disposed on the second rotation member along the third axial direction and is adapted to be fixed to the display.

18. The display stand device according to claim 17, wherein the display and the inclination adjustment member rotate along the first axial direction with the second rotation member as a rotation axis to be parallel to the telescopic assembly, and the telescopic assembly rotates along the first axial direction with the first rotation member as the rotation axis to be parallel to the third axial direction when the display stand device is to be stored together with the display in a storage position.

19. The display stand device according to claim 1, wherein the base is a clamp.

20. The display stand device according to claim 1, wherein the telescopic assembly passes through the first rotation member and is located on two opposite sides of the first rotation member.
